(19) United States
(12) Patent Application Publication
(10) Pub. No.: US 2011/0034154 A1
(43) Pub. Date: Feb. 10, 2011

(54) SYSTEM AND METHOD FOR PROVIDING A REASON FOR IGNORING A CALL

(75) Inventor: Nathan J. Maxfield, Wakefield, MA (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/535,153

(22) Filed: Aug. 4, 2009

(51) Int. Cl. H04M 3/42

(52) U.S. Cl. 455/414.1; 379/210.01

(57) ABSTRACT

A system and method for providing a reason for ignoring an incoming call is disclosed. The system may comprise a network element having one or more computer processors and data storage units, the network element configured to identify an incoming call from a caller, transmit information associated with the incoming call to a user at a first communications device, receive a reason for ignoring the incoming call, and transmit the reason for ignoring the incoming call to the caller at a second communications device.

### BACKGROUND INFORMATION

When a call is received at a user's mobile communications device, such as a mobile phone or personal digital assistant (“PDA”), the user may ignore the call by selecting an “ignore call” option on the mobile communications device. Ignoring the call may be a convenient way to keep the mobile communications device from continuously ringing/vibrating, especially if the user cannot immediately answer the call and speak with the caller. For example, the user may be in the middle of a work-related meeting and cannot readily answer a personal call. However, current mobile communications devices do not provide the caller with a reason as to why his or her call is being ignored. As a result, the caller may continue to call the user's mobile communications device, which may be bothersome to both the caller and the user. Therefore, as mobile communications become increasingly popular, it may be important to have a system and method for providing a comprehensive and efficient way for letting a caller know why his or her call is being ignored.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing a reason for ignoring a call, according to an exemplary embodiment.

FIG. 2 depicts a hardware module component of a system for providing a reason for ignoring a call, according to another exemplary embodiment.

FIGS. 3A-3B depict illustrative screens on a mobile device for providing a reason for ignoring a call, according to an exemplary embodiment.

FIG. 3C depicts an illustrative screen on a mobile device for providing a priority level of a call, according to an exemplary embodiment.

FIG. 4 depicts an illustrative screen on a video display device for providing a reason for ignoring a call, according to an exemplary embodiment.

FIG. 5 depicts an illustrative flowchart of a method for providing a reason for ignoring a call, according to another exemplary embodiment.

FIG. 6 depicts an illustrative flowchart of a method for providing a priority level of a call, according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for providing a reason for ignoring a call. That is, exemplary embodiments may, among other things, expand and optimize communications by comprehensively and effectively providing one or more reasons to a caller as to why his or her incoming call is being ignored. In addition, some embodiments may also provide custom alerts so that a called party may preview an incoming call and/or to see the importance/priority of that incoming call.

Most mobile communications devices (e.g., wireless devices) are typically equipped with a caller identification feature that allows a user of the mobile communications device to preview who is calling. As discussed above, if a user of the mobile communications device is unable to answer a call, the user may initially check to see who is calling, and if the call does not seem important enough to answer, the user may select an ignore option on the mobile communications device. For example, if the user is in the middle of a work-related meeting and his or her spouse calls, the user may recognize that the caller is his or her spouse and assume that the call is not important enough to take at that time. The user may ignore the call and call back later at a more convenient time. By selecting the ignore option, the mobile communications device may stop any further ringing/vibrating at the mobile communications device and the user may continue participating his work-related meeting without further disturbance by that call attempt. The caller, however, may be unaware as to why the call was ignored and may assume, for example, that reception was poor among many other speculative reasons. As a result, the caller may call the user again. In this example, the user may receive one or more additional calls from his or her spouse, which may cause repeated disturbance/distraction, especially if the user is still in his or her work-related meeting. Furthermore, if the caller is calling because of emergency, there may be no way the caller can let the user or called party know that it is an emergency other than calling repeatedly.

In one or more exemplary embodiments, a system and method may be provided so that a user of a wireless device may let the caller know why an incoming call is being ignored. Referring the example described above, the called party who receives a call may select an ignore option and may provide one or more reasons to the caller as to why the call is being ignored. For example, the user may select a reason from a list of reasons provided at the mobile communications device. These may include “In a meeting” or “Busy right now.” Such reasons may then be conveyed to the caller. This way, if the call is unimportant, the caller may simply wait for the user to call back after the meeting or when the user is available. In some embodiments, if the user selects a reason while the call is still being attempted, the reason may be incorporated to a voicemail prompt and may notify the caller during a playback message. This way, when the caller gets transferred to voicemail, he or she can immediately be notified of the reason the user is ignoring the call. In other embodiments, the reason the call has been ignored may be sent to the caller's telephonic device via text message or other similar message (e.g., SMS). A text message may ensure that the caller is notified of the reason, which may be particularly useful if the caller decides not to listen to the voicemail prompt. Other various embodiments may also be provided.

In the event a caller is calling because of an emergency, embodiments of the present invention may also provide a way for the caller to let the called party know that that the call is an emergency. This may prevent repeated calls, which may be inconvenient to both the caller and the called party.

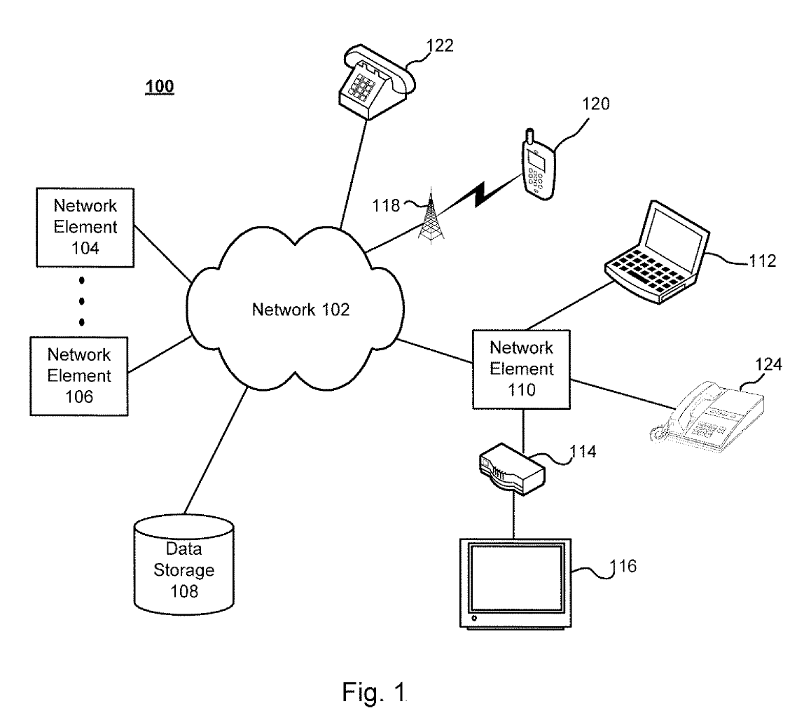

FIG. 1 depicts a block diagram of a system architecture 100 for providing a reason for ignoring a call, according to an exemplary embodiment. As illustrated, network 102 may be communicatively coupled with one or more devices including network element 104, network element 106, data storage 108, and network element 110. Other devices may be communicatively coupled with network 102 via one or more intermediary devices, such as transmitter/receiver 118, network element 110, and/or a wireline phone 122. Wireless device 120 may be communicatively coupled with network 102 via transmitter/receiver 118. Network client 112 and set-top box 114 may be communicatively coupled with network 102 via network element 110. Wireless control 110 may be communicatively coupled with set-top box 114 via infrared, Bluetooth communication, and/or other wireless technologies. A video display (e.g., television set 116) may he communicatively coupled to set-top box 114. It should also be appreciated that other various components may also be communicatively coupled with the network element 110, such as a Voice over Internet Protocol (“VoIP”) phone 124.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, EE 802.11a, 802.11b, 802.15.1, 802.11n and 802.11g or any other wired or wireless network for transmitting and/or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cable television network, corporate networks, and/or home networks.

Network elements 104, 106, 110, and data storage 108 may transmit and receive data to and from network 102 representing broadcast content, user request content, mobile communications data, and/or other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Transmitter/receiver 118 may be a repeater, a microwave antenna, a cellular tower, or another network access device capable of providing connectivity between to different network mediums. Transmitter/receiver 118 may be capable of sending or receiving signals via a mobile network, a paging network, a cellular network, a satellite network or a radio network. Transmitter/receiver 1318 may provide connectivity to one or more wired networks and may be capable of receiving signals on one medium such as a wired network and transmitting the received signals on a second medium, such as a wireless network.

Wireless device 120 may be a mobile communications device, wireline phone, a cellular phone, a mobile phone, a satellite phone, a personal digital assistant (“PDA”), a computer, a handheld MP3 player, a handheld multimedia device, a personal media player, a gaming device, and/or other devices capable of communicating with network 102 via transmitter/receiver 118.

Network elements, transmitter/receiver 118, data storage 108, and set-top box 114 may include one or more processors (not shown) for recording, transmitting, receiving, and/or storing data. Although network elements, transmitter/receiver 118 and data storage 108 are depicted as individual elements, it should be appreciated that the contents of one or more of a network element, transmitter/receiver 118, and data storage 108 may be combined into fewer or greater numbers of devices and may be connected to additional devices not depicted in FIG. 1. Furthermore, the one or more devices may be local, remote, or a combination thereof a first network elements, transmitter/receiver 118, and data storage 108.

Data storage 108 may be network accessible storage and may be local, remote, or a combination thereof to network elements 104, 106, and 110. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, Data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data.

Network elements 104, 106, and 110 may be one or more servers (or server-like devices), such as a Session Initiation Protocol (“SIP”) server. Network elements 104, 106, and 110 may include one or more processors (not shown) for recording, transmitting, receiving, and/or storing data. According to one or more embodiments, network elements 104, 106, and 110 may be servers providing media content to one or more users. In other embodiments, network elements 104, 106, and 110 may be servers that provide network connection between two or more wireless devices 118. Network elements 104, 106, and 110 may also be servers of a service provider, the Internet, a broadcaster, a cable television network, and/or another media provider.

Network element 110 may be a residential gateway, such as a router, an optical network terminal or another piece of Customer Premises Equipment (“CPE”) providing access to one or more pieces of equipment. For example, network element 110 may provide audio/video programming content feeds to a set-top box, such as set-top box 116. Network element 110 may also provide network connectivity for other clients, such as a Voice Over IP (“VOIP”) phone (not shown) and a network client, e.g., network client 112.

Network client 112 may be a desktop computer, a laptop computer, a server, a personal digital assistant, or other computer capable of sending and/or receiving network signals. Network client 112 may use a wired or wireless connection. Although depicted as connected via a residential gateway in FIG. 1, it should be appreciated that the network client 112 may connect directly to network 102 and/or via other network connectivity devices as well. According to one or more embodiments, network client 112 using a wireless connection may authenticate with a network using Wired Equivalent Privacy (“WEP”), Wi-Fi Protected Access (“WPA”), and/or other wireless network security standards.

According to one or more embodiments, set-top box 114 may receive a media selection, such as a channel selection from a user (e.g., via wireless remote (not shown)). Set-top box 114 may provide the programming feed corresponding to the selected media channel. According to some embodiments, set-top box 114 may analyze metadata to identify search criteria related to the media selection. The metadata may be local to set-top box 114 or remote from set-top box 114. For example, set-top box 114 may analyze closed captioning data associated with the selected programming feed, electronic program guide information associated with the programming feed, or other metadata. Set-top box 114 may request, query, or otherwise interface with remote sources of data. According to some embodiments, set-top box 114 may forward selection data to one or more network components, such as one or more of network elements 104, 106, and 110. Set-top box 114 may also forward metadata associated with a media selection to one or more network elements, such as network elements 104, 106, and 110. According to some embodiments, set-top box 114 may forward only a channel selection and one or more network elements may separately obtain metadata.

System 100 may be used for mobile telecommunications between two or more components of the system 100, e.g., two or more wireless devices, wireless device with network client, set top box with wireless device, landline phone, VoIP, etc. System 100 may also be used for transmitting and/or receiving multimedia content. The various components of system 100 as shown in FIG. 1 may be further duplicated, combined and/or integrated to support various applications and platforms. Additional elements may also be implemented in the systems described above to support various applications.

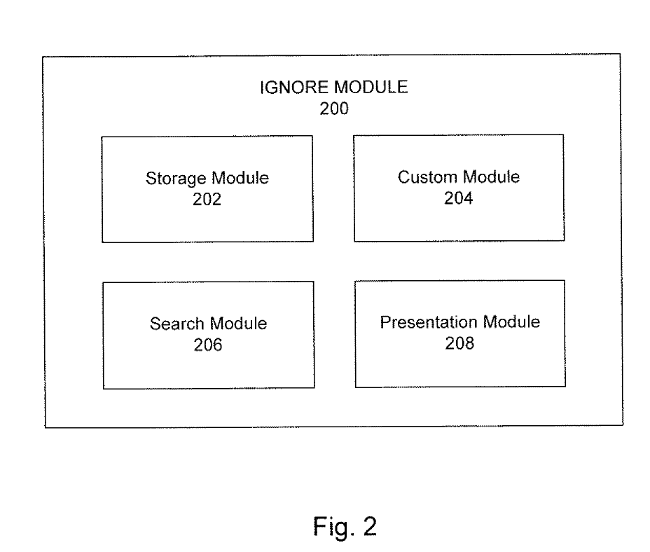

FIG. 2 depicts a hardware module component of a system for providing a reason for ignoring a call, according to another exemplary embodiment. Referring to FIG. 2, there is shown an ignore/priority module 200 for providing a reason for ignoring a call in accordance with an embodiment of the present disclosure. As illustrated, the ignore/priority module 200 may contain one or more components, such as a storage module 202, a custom module 204, a search module 206, and/or a presentation module 208. Although the ignore/priority module 200 is depicted as a single module, functionality and/or modules of the ignore/priority module 200 may be located on a single device/component or distributed across a plurality of devices/components, such as including one or more centralized servers and/or one or more pieces of customer premises equipment or end user devices. In some embodiments, components of ignore/priority module 200 may be incorporated within a wireless device, such as a mobile phone.

Storage module 202 may manage or access electronic storage including databases and other organized electronic storage. Storage module 202 may provide one or more interfaces for custom module 204, the search module 206, and/or presentation module 208. Storage module 202 may store reasons for ignoring a call or other similar data. These may include reasons, such as “In a meeting,” “Busy,” “Currently unavailable,” “Traveling,” “Hiking,” “Sleeping,” “All tied up,” “Don't want to talk to you,” “Call me later,” etc.

Custom module 204 may receive input from a user to customize one or more reasons for ignoring a call. For example, custom module 204 may provide an interface for the user to input his or her own reasons for ignoring call. A user may enter his or reasons via the interface. It should be appreciated that the customized reason may also be stored in the storage module 202, e.g., for future selection and use.

Search module 206 may receive input or other search criteria from one or more user queries/searches. Search module 206 may interface with the storage module 202 and with a user at a wireless device (e.g., mobile communications device) and/or a multimedia display device (e.g., a television set via a set top box) to receive reasons for ignoring a call or other data. In this example, the user may select a reason for ignoring a call from a plurality of reasons stored in storage module 202. The search module 206 may provide various searching methods and processes for a user to find a reason to ignore a call.

Formatting may be included in the search module 206 so that the search results may be transmitted/received in format compatible with one or more user devices. For example, search results may be formatted as extensible Markup Language (“XML”) and provided to a user as a Really Simple Syndication (“RSS”) feed. Search results may also be optically packaged for speedy delivery over network 102 or may be packaged according to specified preferences. Other formatting parameters may also be provided.

Presentation module 208 may interface with a user at a wireless device (e.g., mobile communications device) and/or a multimedia display device (e.g., a television set via a set top box). Presentation module 208 may present the user a graphical interface with which the user may select one or more reasons to ignore a call. Therefore, the presentation module 208 may interface with the storage module 202, the custom module 204, and/or the search module 206 so that the user may send a caller his or her reason for ignoring an incoming call.

The ignore/priority module 200 may provide a way for a user to let a caller know why his or her call is being ignored. In some embodiments, the ignore/priority module 200 may be implemented server-side, e.g., with network elements 104 and/or 106. In other embodiments, the ignore/priority module 200 may be implemented client-side, e.g., with network element 110, network client 112, set top box 114, and/or wireless device 120.

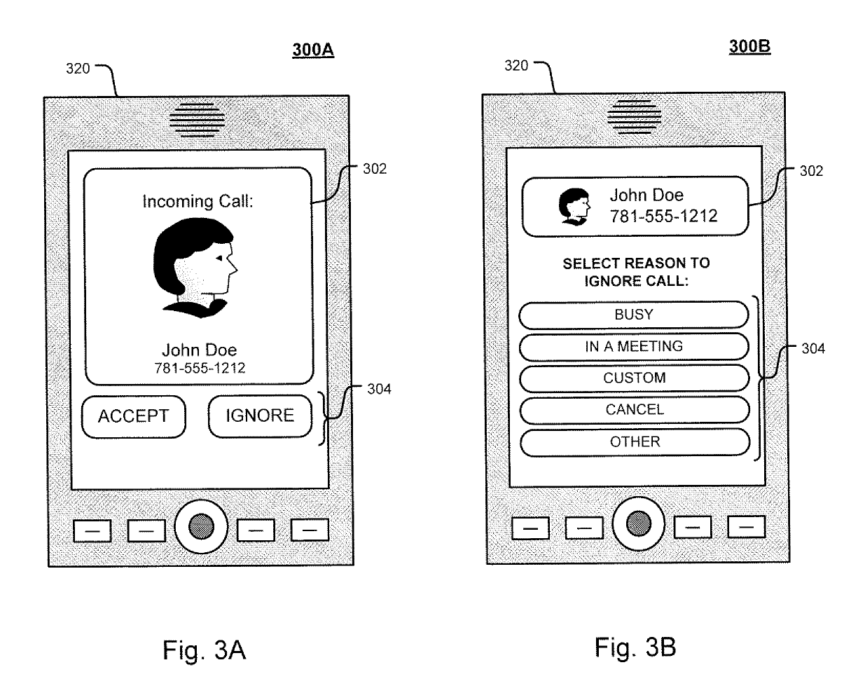

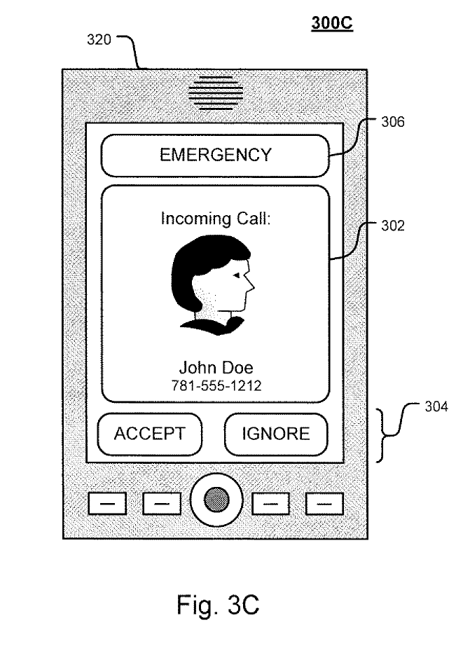

FIGS. 3A-3C depict illustrative screens on a mobile device for providing a reason for ignoring a call, according to an exemplary embodiment. Referring to FIG. 3A, an illustrative screen 300A may be provided at a wireless device 320. The illustrative screen 300A may include a window 302 showing caller information. For example, in some embodiments, an “Incoming Call” may be identified in this window 302. A picture, a name, and/or a calling number/identifier may also be provided in window 302. The screen 300A may also include one or more selectable options 304, such as an “Accept” option and an “Ignore” option. The “Accept” option may allow the user to answer the call from the caller, e.g., John Doe, and the “Ignore” option may allow the user to ignore the call from the caller. The user may select either option by pressing the screen (or corresponding button) of the wireless device 320.

In the event the user selects the “Ignore” option, another illustrative screen 300B may be presented, as depicted in FIG. 3B. The screen 300B of FIG. 3B may continue to display the caller's information (e.g., picture, name/identifier, phone number, etc) in a window 302. In addition, the screen 300B may also display one or more selectable options 304. These one or more selectable options 304 may include reasons to ignore the call, which will be forwarded to the caller (e.g., John Doe) when selected by the user. In this example, the reasons for ignoring a call from the caller may include “Busy,” “In a meeting,” “Custom,” “Cancel,” and/or “Other.” The “Busy” and “In a meeting” options may be predetermined reasons stored in the storage module 202 of the ignore/priority module 200. Other various predetermined reasons may also be stored and/or presented. The “Custom” option may be another selectable option and may provide an interface for the user of the wireless device 320 to enter his or her own customized reason for ignoring the call. For example, once the user selects the “Custom” option, the user may interface with the custom module 204 and enter, via the wireless device, his or her own reasons for ignoring the call, e.g., “I am working out, call you later.”

A “Cancel” option may be another selection option and be provided in the event the user mistakenly selected the “Ignore” option from screen 300A. If the call is attempting to connect, the “Cancel” option may allow the user to go back to screen 300A and select the “Accept” option to answer the call.

It should be appreciated that an “Other” option may also be provided at screen 300B for other various functionalities and features.

It should also be appreciated that ignore/priority module 200 may also be used by a caller to indicate priority of a call to the called party. FIG. 3C depicts an illustrative screen 300C on a mobile device for providing a priority of a call, according to an exemplary embodiment. In this example, the ignore/priority module 200 may allow a caller to indicate a level of priority of a call. The storage module 202, the custom module 204, search module 206, and/or presentation module 208 of the ignore/priority module 200 may allow the caller to choose from a menu of priority levels, generate a custom priority, and/or search for priority levels in storage, similar to the way a called party may select/create a reason for ignoring a call, as described above.

Referring to FIG. 3C, the screen 300C may continue to display the caller's information (e.g., picture, name/identifier, phone number, etc.) in a window 302. In addition, the screen 300C may also display one or more selectable options 304, such as “Accept” or “ignore.” However, screen 300C may also show the called party a priority box 306, indicating the priority of the call. In this example, the priority box 306 indicates that the call from “John Doe” is an “EMERGENCY.” Other priority levels may also be provided, such as “Important,” “Not important,” and/or a customized level (e.g., “PICK UP) NOW!”).

While this may be useful in situations where a caller need to notify the called party of the priority of a call in a personal and/or work-related situation, providing custom alerts indicating call priority may also be useful in emergency situations. For example, the Federal Emergency Management Agency (FEMA) may send an emergency custom alert to all home phones in a particular area code and/or zip code to warn of an emergency. In other embodiments, for example, an emergency custom alert may be sent to cell phones off of a communications tower (e.g., mobile transceiver/receiver 118). Here, the emergency custom alert may let the called party know that a call is high priority and from FEMA to warn of a dam collapse sending flood waters rushing down to a nearby town or city. In particular, the custom alert may instruct residents and drivers to seek higher ground immediately and avoid driving on roads.

Although a reason to ignore call and/or priority level has been primarily directed to a visible message on a device, it should be appreciated that other various modes of presentation may also be provided. For example, the reason and/or priority level may be stored, searched, and/or presented in an audio format (e.g., a custom ringtone).

In other embodiments, the user may indicate on his or her device one or more reasons to ignore a call before an incoming call is received. For instance, a user may preset his or her device with his current status, e.g., “Busy,” “In a meeting,” “Unavailable,” “Call you later,” and/or other status indicators. In this example, when an incoming call is registered at the user's wireless device, the ignore/priority module 200 may automatically inform the caller at his or her calling device know of the user's preset status.

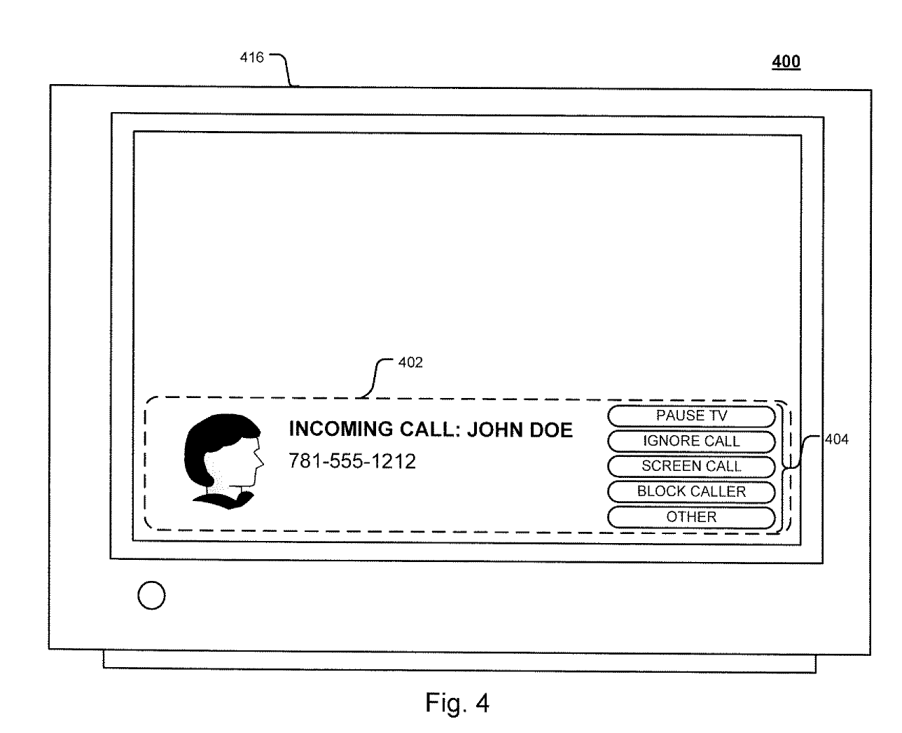

It should be appreciated that while embodiments are primarily directed to handling incoming calls via a mobile communications device, other variations and/or various implementations may also be provided. FIG. 4 depicts an illustrative screen 400 on a video display device for providing handling an incoming call, according to an exemplary embodiment. In this example, an illustrative screen 400 may be provided at a video display device, e.g., a television set 416. The illustrative screen 400 may be playing multimedia on the display when an incoming call is received. The incoming call may be received via the network element 110 over the network 102. As described above, one or more network clients 112, which may include a mobile communications device, and/or set top boxes may identify the incoming call and display in a window 402 on the television set 416. The window 402 may display caller information. For example, an “Incoming Call” may be identified in this window 402. A picture, a name, and/or a calling number/identifier may also be provided in window 402. The screen 3400 may also include one or more selectable options 404, such as an “Ignore Call” option. The “Ignore Call” option may allow the user/viewer to ignore the call from the caller. A “Pause TV” option may allow the user to pause current television programming so that he or she may answer the call from the caller, e.g., John Doe, without disruption during a TV program. A “Screen Call” option may also be provided, which may allow a user to get more information about the call/caller and/or stop all future calls during that particular TV programming. A “Block Caller” option may also be provided so that the user/viewer may ignore a particular caller (e.g., “John Doe”) for a predetermined time, e.g., the duration of the show. An “Other” option may also be provided for other various selectable options and/or embodiments. It should also be appreciated that the user/viewer may interact with the screen 400 via remote control and/or by touchscreen. Other various inputs and embodiments may also be provided.

By linking received calls with one or more other devices, such as a set top box or TV, a user/viewer may be able to maximize his or her entertainment pleasure without undue burden or inconvenience, much like when in a work-related meeting. Although described primarily with respect to a television display, it should be appreciated that a variety of device interconnectivity may also be implemented.

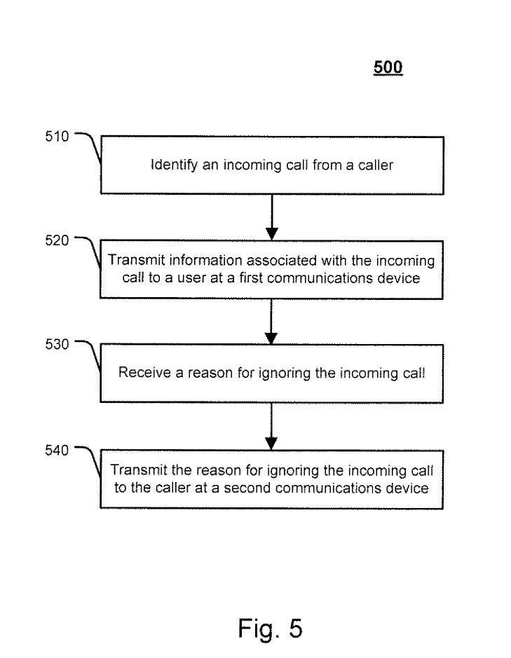

FIG. 5 depicts an illustrative flowchart of a method for providing a reason for ignoring a call, according to an exemplary embodiment. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least system 100 in FIG. 1 and component 200 in FIG. 2, by way of example, and various elements of systems 100 and 200 are referenced in explaining the exemplary method of FIG. 5. Each block shown in FIG. 5 represents one or more processes, methods, or subroutines carried in the exemplary method 500. A computer readable medium comprising code to perform the acts of the method 500 may also be provided. Referring to FIG. 5, the exemplary method 600 may begin at block 510.

At block 510, an incoming call from a caller may be identified by the ignore/priority module 200, which may be incorporated in a network element comprising one or more computer processors and data storage units. The network element may be at least one of network element 110, network client 112, set top box 114, and a wireless device 120.

At block 520, information associated to the incoming call may be transmitted to a user at a first communications device (e.g., a mobile phone). In this example, the information may include caller identifier information, such as name, phone number, image, etc., and/or other information.

At block 530, a reason for ignoring the incoming call may be received at the network element. For example, in some embodiments, an instruction to ignore the incoming call may first be received at the network element. For example, the user may select an option to ignore the incoming call at the first communications device. In some embodiments, a selectable option to ignore the incoming call may be transmitted to the first communications device as an option for the user to select.

In other embodiments, one or more selectable reasons from which a user selects a reason for ignoring the incoming call may be provided to the first communications device. In some embodiments, the one or more selectable reasons may comprise at least one of the following reasons: “busy,” “in a meeting,” “unavailable,” and “custom.” The custom reason may allow the user of the first communications device to generate a customized reason for ignoring the incoming call, as described above.

It should be appreciated that the one or more selectable reasons may be stored in the storage module 202. Also, it should be appreciated that the search module 206 may provide a user interface to search for the one or more reasons for ignoring the incoming call.

At block 540, the reason for ignoring the incoming call may be transmitted to the caller at a second communications device (e.g., a mobile phone). In some embodiments, the reason for ignoring the incoming call may be in at least one of the following formats: voicemail, text message, image, and multimedia.

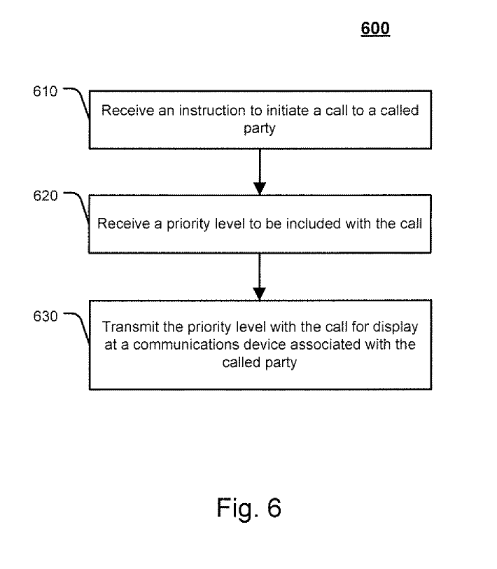

FIG. 6 depicts an illustrative flowchart of a method for providing a priority level of a call, according to another exemplary embodiment. The exemplary method 600 is provided by way of example, as there are a variety of ways to carry out methods disclosed herein. The method 600 shown in FIG. 6 may be executed or otherwise performed by one or a combination of various systems. The method 600 is described below as carried out by at least system 100 in FIG. 1 and component 200 in FIG. 2, by way of example, and various elements of systems 100 and 200 are referenced in explaining the exemplary method of FIG. 6. Each block shown in FIG. 6 represents one or more processes, methods, or subroutines carried in the exemplary method 600. A computer readable medium comprising code to perform the acts of the method 600 may also be provided. Referring to FIG. 6, the exemplary method 600 may begin at block 610.

At block 610, instructions to initiate a call to a called party may be received by the ignore/priority module 200, which may be incorporated in a network element comprising one or more computer processors and data storage units. The network element may be at least one of network element 110, network client 112, set top box 114, and a wireless device 120. In some embodiments, a selectable option to provide a priority level for the call may be provided.

At block 620, a priority level may be received by the network element to be included with the call. In some embodiments, one or more selectable priority levels from which a user selects a priority level for the call may be provided. In this example, the one or more selectable priority levels may comprise at least one of the following priority levels: “emergency,” “important,” “not important,” and “custom.” The custom priority level may allow the user to generate a customized priority level of the call, as discussed above,

It should be appreciated that the one or more selectable priority levels may be stored in the storage module 202. It should also be appreciated that the search module 206 may allow a user the ability to search for the one or more priority levels for the call.

At block 630, the priority level may be transmitted with the call for display at a communications device associated with the called party. In some embodiments, the priority level for the call may be in at least one of the following formats: voicemail, text message, image, and multimedia.

In summary, embodiments may provide a system and method for comprehensively and effectively providing a reason for ignoring a call and/or a priority level of a call. It should be appreciated that although embodiments are described primarily with incoming phone calls, the systems and methods discussed above are provided as merely exemplary and may have other applications. These may include emergency alerts, voicemail previews, dissemination of various news/information, etc.

While depicted as various servers and/or devices, it should be appreciated that embodiments may be constructed in software and/or hardware, as a separate and/or stand-alone device, physical and/or virtual, or as pan of an integrated transmission and/or switching device.

Additionally, it should also be appreciated that system support and updating the various components of the system may be easily achieved. For example, a system administrator may have access to one or more of the components of the system, network, and/or device. It should also be appreciated that the one or more system components, servers, and/or devices of the system may not be limited to physical components. These components may be software based, virtual, etc. Moreover, the various components, servers, and/or devices may be customized to perform one or more additional features and functionalities. Such features and functionalities may be provided via deployment, transmitting and/or installing software/hardware.

It should also be appreciated that each of the communications devices, servers, and/or network elements may include one or more processors (not shown) for providing a reason for ignoring a call and/or priority level of a call. It should be appreciated that one or more data storage systems (e.g., databases) (not shown) may also be coupled to each of the devices or servers of the system. In one embodiment, the one or more data storage systems may store relevant information for each of the servers and system components.

It should be appreciated that the contents of any of these one or more data storage systems may be combined into fewer or greater numbers of data storage systems and may be stored on one or more data storage systems and/or servers. Furthermore, the data storage systems may be local, remote, or a combination thereof to clients systems, servers, and/or other system components. In another embodiment, information stored in the databases may be useful in providing additional personalizations and customizations.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

We claim:

1. A method, comprising:
identifying, at a network element, an incoming call from a caller,
transmitting information associated with the incoming call to a user at a first communications device;
receiving, at the network element, a reason for ignoring the incoming call; and
transmitting the reason for ignoring the incoming call to the caller at a second communications device.

2. The method of claim 1, further comprising presenting a selectable option to ignore the incoming call.

3. The method of claim 1, further comprising presenting one or more selectable reasons from which a user selects a reason for ignoring the incoming call.

4. The method of claim 3, wherein the one or more selectable reasons comprises at least one of the following reasons: busy, in a meeting, unavailable, and custom.

5. The method of claim 4, wherein the custom reason allows the user of the first communications device to venerate a customized reason for ignoring the incoming call.

6. The method of claim 3, further comprising storing the one or more selectable reasons in a storage module.

7. The method of claim 1, further comprising providing, via a search module, a user the ability to search for the one or more reasons for ignoring the incoming call.

8. The method of claim 1, wherein the reason for ignoring the incoming call in at least one of the following formats: voicemail, text message, image, and multimedia.

9. The method of claim 1, wherein the network element comprises a processing module associated with at least one of a mobile communications device, wireline phone, a cellular phone, a mobile phone, a satellite phone, a personal digital assistant (“PDA”), a computer, a handheld MP3 player, a handheld multimedia device, a personal media player, a gaming device, a server, and a data storage unit.

10. The method of claim 1, wherein the information associated with the incoming call comprises one or more selectable priority levels.

11. The method of claim 10, wherein the one or more selectable priority levels comprises at least one of the following priority levels: emergency, important, not important, and custom.

12. The method of claim 10, wherein the one or more selectable priority levels is used by the user to decide whether to ignore the incoming call.

13. The method of claim 10, wherein the one or more selectable priority levels overrides the reason for ignoring the call.

14. A computer readable medium comprising code to perform the acts of the method of claim 1.

15. A system, comprising:
a network element comprising one or more computer processors and data storage units, the network element configured to identify an incoming call from a caller, transmit information associated with the incoming call to a user at a first communications device, receive a reason for ignoring the incoming call, and transmit the reason for ignoring the incoming call to the caller at a second communications device.

16. The system of claim 15, wherein the network element is further configured to present a selectable option to ignore the incoming call.

17. The system of claim 15, wherein the network element is further configured to present one or more selectable reasons from which a user selects a reason for ignoring the incoming call.

18. The system of claim 17, wherein the one or more selectable reasons comprises at least one of the following reasons: busy, in a meeting, unavailable, and custom.

19. The system of claim 18, wherein the custom reason allows the user of the first communications device to generate a customized reason for ignoring the incoming call.

20. The system of claim 17, wherein the network element is further configured to store the one or more selectable reasons in a storage module.

21. The system of claim 15, wherein the network element is further configured to provide, via a search module, a user the ability to search for the one or more reasons for ignoring the incoming call.

22. The system of claim 15, wherein the reason for ignoring the incoming call in at least one of the following formats: voicemail, text message, image, and multimedia.

23. The system of claim 15, wherein the network element comprises a processing module associated with at least one of a mobile communications device, wireline phone, a cellular phone, a mobile phone, a satellite phone, a personal digital assistant (“PDA”), a computer, a handheld MP3 player, a handheld multimedia device, a personal media player, a gaming device, a server, and a data storage unit.

24. The system of claim 15, wherein the information associated with the incoming call comprises one or more selectable priority levels.

25. The system of claim 24, wherein the one or more selectable priority levels comprises at least one of the following priority levels: emergency, important, not important, and custom.

26. The system of claim 24, wherein the one or more selectable priority levels is used by the user to decide whether to ignore the incoming call.

27. The system of claim 24, wherein the one or more selectable priority levels overrides the reason for ignoring the call.
